(19) United States
(12) Patent Application Publication
(10) Pub. No.: US 2021/0349308 A1
(43) Pub. Date: Nov. 11, 2021

(54) SYSTEM AND METHOD FOR VIDEO PROCESSING USING A VIRTUAL REALITY DEVICE

(71) Applicants: Szu Wen FAN, Markham (CA); Hengguang ZHOU, Richmond Hill (CA); Qiang XU, Richmond Hill (CA); Wei LI, Markham (CA)

(72) Inventors: Szu Wen FAN, Markham (CA); Hengguang ZHOU, Richmond Hill (CA); Qiang XU, Richmond Hill (CA); Wei LI, Markham (CA)

(21) Appl. No.: 17/244,807

(22) Filed: Apr. 29, 2021

Related U.S. Application Data
(60) Provisional application No. 63/020,518, filed on May 5, 2020.

(51) Int. Cl. G02B 27/00; G02B 27/01

(52) U.S. Cl. CPC G02B 27/0075; G02B 27/0093; G02B 2027/0123; G02B 27/0025; G02B 27/0172

(57) ABSTRACT

Systems and methods for processing an omnidirectional video (ODV) in virtual reality are provided. The method may include: recording virtual reality field of view (VRFOV) data corresponding to the ODV displayed by a VR display device, where the ODV has a plurality of ODV frames in chronological order, each of the ODV frames including ODV image data and a unique ODV frame timestamp, the VRFOV data representing, for each ODV frame, spatial parameters for a subset of the ODV image data corresponding to a field of view (FOV) presented by the VR display device and an ODV frame identifier for the ODV frame; for each ODV frame in the plurality of ODV frames, extracting the subset of the ODV image data indicated in the VRFOV data to generate a respective regular field of view (RFOV) video frame; and storing the generated RFOV video frames as a video file.

### RELATED APPLICATIONS

This patent application claims priority to and the benefit of U.S. Provisional Patent Application No. 63/020,518, filed on May 5, 2020, the entirety of which is herein incorporated by reference.

### TECHNICAL FIELD

The present disclosure relates to video processing, and in particular, to a system and method for video processing using a virtual reality (VR) display device.

### BACKGROUND

A traditional camera typically has a field of view of less than 180°. An omnidirectional camera (ODC), in comparison, has a field of view from 180° to 360° in the horizontal plane, and often can capture the entire sphere surrounding the ODC. A user can thus first record a panorama scene spanning 360°, and then later pick and choose the most relevant or interesting scenes or frames through editing. Similarly, an omnidirectional video (ODV) captured by an ODC includes multiple video frames, with each frame having a field of view ranging from 180° to 360° in the horizontal plane. However, an ODV, especially one that has a field of view of 360°, may appear distorted when viewed on a conventional display (e.g. a computer or a television screen). An editing step, which converts the ODV into a regular field of view (RFOV) video, is often necessary for the ODV to be converted to a format that can be properly displayed on a conventional display to appear as though the RFOV video had been recorded with a conventional camera in the first place.

Extracting RFOV video frames from an ODV can be a time consuming process that requires a user to examine individual scenes or frames of the ODV and, if necessary, manually edit a number of spatial parameters including field of view (or zoom), yaw, pitch and roll for each individual frame. The user also needs to be mindful of the temporal dynamics of the frames—i.e., to ensure that the edited consecutive video frames still result in a fluid movie when played, instead of a collection of individual pictures.

An improved solution for processing an ODV is therefore desired.

### SUMMARY

The embodiments described herein provide a system and methods to view and edit an omnidirectional video (ODV) using a virtual reality (VR) display device such as a head-mounted display (HMD) device. Compared to desktop editing software that displays a distorted view of an ODV frame, the use of a VR display device facilitates an immersion experience for a user to view and edit an ODV in a convenient and intuitive manner.

In one aspect, there is provided a method, which may include the steps of: recording virtual reality field of view (VRFOV) data corresponding to an ODV displayed on a display screen of a VR display device, where the ODV has a plurality of ODV frames in chronological order, each of the ODV frames including spatially arranged ODV image data and having a unique ODV frame timestamp, the VRFOV data representing, for each of a plurality of ODV frames, spatial parameters for a subset of the ODV image data corresponding to a field of view (FOV) presented by the VR display device and an ODV frame identifier for the ODV frame; for each ODV frame in the plurality of ODV frames, extracting the subset of the ODV image data indicated in the VRFOV data to generate a respective regular field of view (RFOV) video frame; and storing the generated RFOV video frames as a video file.

In another aspect, there is provided a system including a processor and a memory coupled to the processor, the memory tangibly storing thereon executable instructions that, when executed by the processor, may cause the system to: record VRFOV data corresponding to an ODV displayed on a display screen of a VR display device, where the ODV has a plurality of ODV frames in chronological order, each of the ODV frames including spatially arranged ODV image data and having a unique ODV frame timestamp, the VRFOV data representing, for each of a plurality of ODV frames: spatial parameters for a subset of the ODV image data corresponding to a field of view (FOV) presented by the VR display device and an ODV frame identifier for the ODV frame; for each ODV frame in the plurality of ODV frames, extract the subset of the ODV image data indicated in the VRFOV data to generate a respective regular field of view (RFOV) video frame; and store the RFOV video frames as a video file. The ODV frame identifier may be for example the unique timestamp of a respective ODV frame.

By recording, in real time or near real time, spatial parameters from a VR display device and associating the spatial parameters to a specific timestamp (or frame identifier) for each ODV frame in an ODV, the system can generate or construct a RFOV video without having to replicate or store the ODV image data specifically for each frame of the RFOV video. Moreover, a user can easily manipulate the ODV or the RFOV video through the VE display device by a simple head or hand motion, instead of having to manually set or edit a timeline of the ODV.

In all embodiments, the method may include, prior to extracting the subset of the ODV image data for each ODV frame, updating the spatial parameters in the stored VRVOF data for at least one ODV frame in the plurality of ODV frames based on user input data from the VR display device.

In all embodiments, the spatial parameters for at least one ODV frame in the plurality of ODV frames may include: a set of coordinates in quaternion orientation (“quaternion coordinates”), a set of Cartesian coordinates, or a set of coordinates in Euler Angles.

In all embodiments, the spatial parameters for at least one ODV frame may further include a FOV size. The FOV size may be determined based on a default setting and any applicable zoom factor.

In some embodiments, the method may include, for each of a plurality of ODV frames: sensing a head orientation of a user wearing the VR display device when the user is viewing a respective ODV frame from the plurality of ODV frames; and determining the VRFOV data for the respective ODV frame based on the head orientation.

In some embodiments, the VR display device may be a head-mounted display (HMD) worn by the user, and the system may include the HMD.

In some embodiments, the field of view (FOV) presented by the VR display device is pre-determined based on a user setting.

In some embodiments, the user input may be received from a user wearing the VR display device when the user is viewing the at least one ODV frame in the plurality of ODV frames on the display screen, and may include at least one of: a head orientation, a hand gesture, a voice command, an eye movement, and an input from a control unit of the VR display device.

In some embodiments, updating the spatial parameters in the stored VRVOF data for the at least one ODV frame based on the user input may include: updating at least one value from the spatial parameters based on a translation or rotation movement indicated by the user input.

In some embodiments, updating the spatial parameters in the stored VRVOF data for the at least one ODV frame based on the user input may include: updating a FOV size in the spatial parameters based on a movement indicated by the user input.

### BRIEF DESCRIPTION OF THE DRAWINGS

Reference will now be made, by way of example, to the accompanying drawings which show example embodiments of the present application, and in which:

FIG. 1 shows an example ODV frame;

FIG. 2 shows an example ODV frame and a corresponding example RFOV video frame;

FIG. 3 illustrates a block diagram of an example RFOV video generation system in connection with a VR display device, in accordance with one example embodiment of the present disclosure;

FIG. 4 illustrates a block diagram of a computing system implementing an example RFOV video generation system, in accordance with one example embodiment of the present disclosure;

FIG. 5 shows example RFOV video frames as displayed by a VR display device worn by a user;

FIG. 6 shows example RFOV video frames, each overlaying an ODV frame, as displayed by a VR display device worn by a user;

FIG. 7 illustrates a user wearing a VR display device;

FIG. 8 illustrates an example three-dimensional coordinate system of a VR display device;

FIG. 9 illustrates a user editing an ODV through a VR display device, in accordance with one example embodiment of the present disclosure;

FIG. 10A shows an example sequence of RFOV video frames generated from an ODV, in accordance with one example embodiment of the present disclosure.

FIG. 1013 illustrates a simplified schematic diagram of generating a RFOV video based on multiple RFOV video frames, in accordance with one example embodiment of the present disclosure; and

FIG. 11 illustrates an example process performed by an example RFOV video generation system, in accordance with one example embodiment of the present disclosure.

FIG. 12 is a block diagram of a processing system that may be configured to implement disclosed systems and methods according to example embodiments.

### DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this disclosure will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although they are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except where indicated otherwise either explicitly or inherently by context.

Field of view (FOV) is an observable area a person can see, at any given moment, through his or her eyes or via an optical device (e.g. a VR display device). A regular FOV (RFOV) can be considered to be anywhere from 0° to 180°, which is suited for display on a flat screen such as a computer monitor or a TV screen, whereas a FOV produced by an ODC is typically larger than 180°, and often up to 360°. Images and ODVs produced by an ODC with FOVs larger than 180° can appear distorted when displayed on a flat screen, thus requiring additional video processing steps in order to be viewed properly by an audience with a flat screen display.

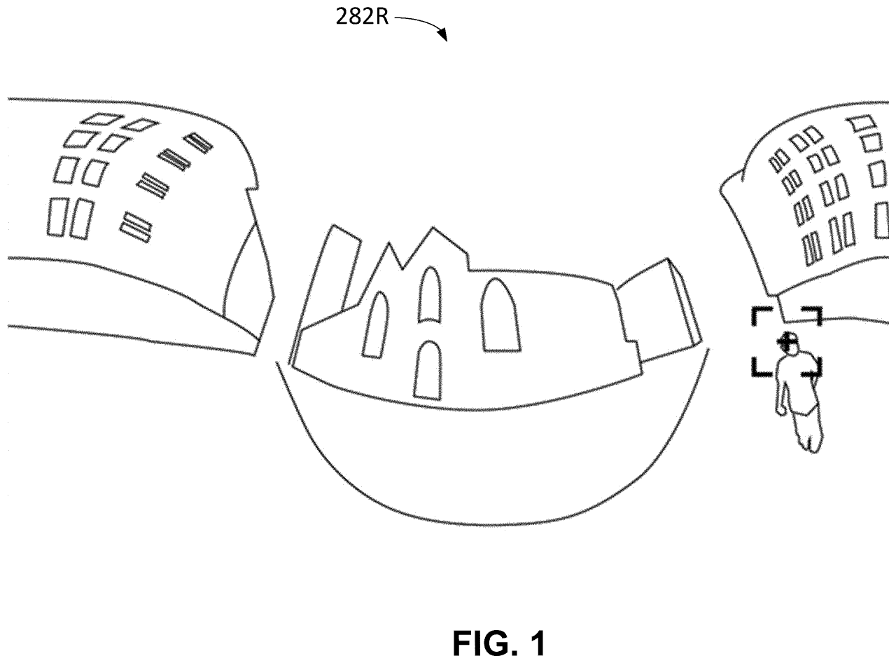

As noted above, generating RFOV video frames from an ODV can be a time consuming process that requires a user to loop through the ODV while moving a RFOV virtual camera's focus region by changing spatial parameters such as FOV, yaw, pitch, and roll parameters, for example. This process divides the user's attention between a temporal aspect and a spatial aspect of the ODV, as the user needs to constantly switch between scrubbing the ODV timeline and changing the RFOV virtual camera's spatial parameters. Moreover, editing an ODV on a computer or laptop screen is difficult as the display of the ODV can be distorted, for example, FIG. 1 illustrates an example of a distorted rendering 282R of a video frame of an ODV captured by an ODC.

Some existing computer vision algorithms can detect salient RFOV regions in consecutive ODV frames to automatically track and extract a sequence of RFOV video frames, however, the application of such a computer vision algorithm is limited, since the lack of human touch from the editing process can result in a fairly rigid RFOV video.

Embodiments disclosed herein provide an immersive, user-friendly video processing experience by displaying an ODV using a VR display device and detecting user input from the VR display device to edit the ODV. The described systems and methods can support concurrent or simultaneous editing of both spatial and temporal aspects of a video via the VR display device, and provide a unified virtual user interface for doing so.

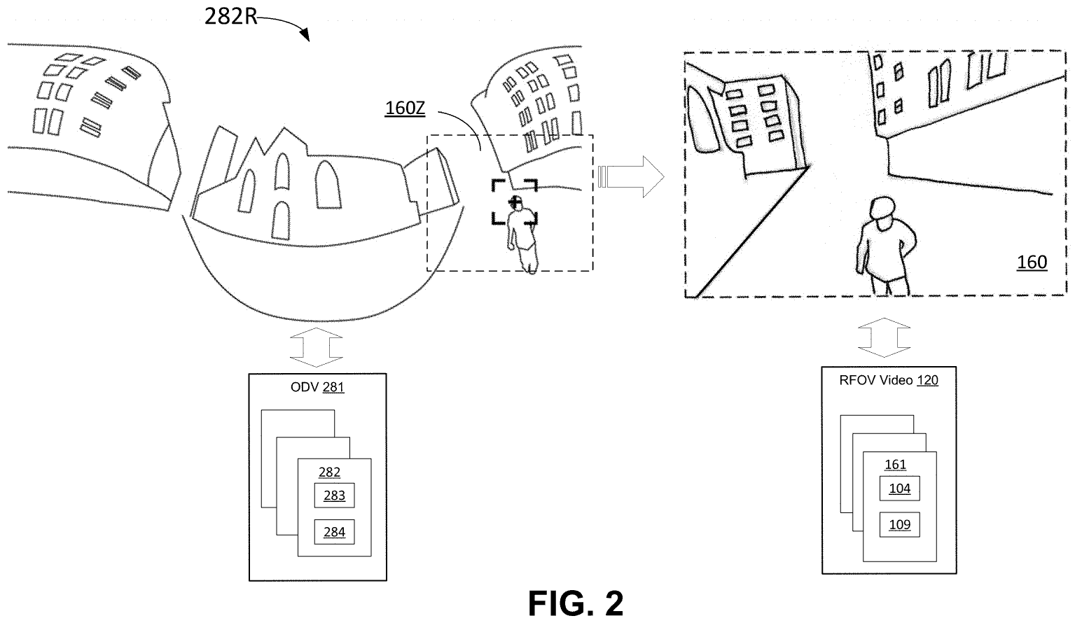

By way of context, the lower half FIG. 2 shows a block diagram representation of an ODV 281 and a corresponding RFOV video 120. The upper half of FIG. 2 shows a flattened 2-dimensional image 282R rendered based on an example ODV frame 282 of the ODV 281, and a corresponding 2-dimensional image rendering 160 of a corresponding RFOV video frame 161 of an RFOV video 120. The ODV 281 includes multiple, consecutive ODV frames 282, with a frequency of a specific number of frames per second. For example, an ODV may have 24, 50, or 60 frames per second. The consecutive ODV frames 282 are in chronological order.

Each ODV frame 282 is identified by a respective timestamp and corresponds to a respective omnidirectional image that is represented as ODV image data. In this regard. Each ODV frame 282 includes ODV image data 283 and a respective chronological identifier such as a timestamp 284. In example embodiments, ODV image data 283 defines a set of spatially arranged display attributes for a fixed number of pixels. For example, the ODV image data 282 for a frame may define a matrix of values, with each value defining a respective display attribute (e.g. an R, G or B value for an RGB image) for a pixel. The location of the attributes for a pixel in the matrix maps to a relative location of the pixel within a displayed image. For example, color attributes could be arranged in a matrix that represent 1920×1080 pixels, 2704×1520 pixels, 3840×2160 pixels, or more. A common matrix arrangement to represent pixels may be H*W*3, where H*W is the number of pixels, and 3 is the number of color attributes per pixel. In the case of 3D representations, additional attributes may be provided per pixel.

RFOV video 120 also has multiple, consecutive RFOV video frames 161 in chronological order. Each RFOV video frame 161 also includes image data (e.g., RFOV image data 104) and a respective frame identifier 109, which may be a timestamp. As will be explained in greater detail below, the RFOV image data 104 is extracted from the ODV image data 283 of a corresponding ODV frame 281. In this regard, in FIG. 2, the extracted RFOV image data 104 for image frame 161 corresponds to a subset of ODV image data 283 that is represented by image region 160Z in rendered ODV frame 282R. A resulting rendered image 160 generated in respect of RFOV image data 104 is also illustrated in FIG. 2 can be similarly organized in a matrix of pixel attribute values of h*w*3, where h*w is a subset of the H*W pixels that are defined in the ODV image data 283.

The specific location of a pixel within an ODV image may be mapped, based on the matrix location of the attribute information for that pixel in the corresponding image data 283 to or from a set of coordinates in the frame reference of a camera, such as the ODC. As will be described in detail below, a location of a pixel in the ODV image data (i.e., the location of the attribute values that define the pixel in the ODV image data) can be mapped to coordinates in a Cartesian system, a Euler Angle system or a quaternion system.

For RFOV image data 104 in a RFOV video frame 161, a location for each pixel may be represented using either 2D or 3D coordinate system, though in most cases the RFOV image data will be generated to be displayed on a flat screen of the display device, e.g., a computer monitor or a TV screen.

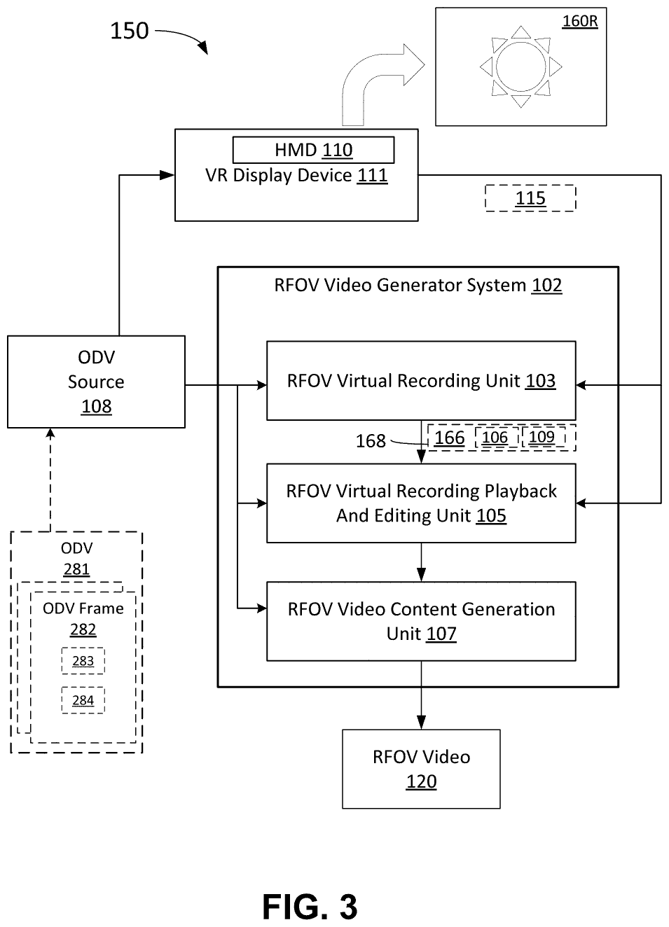

FIG. 3 illustrates a block diagram of a video processing system 150 that includes an example RFOV video generator system 102, a VR display device 111 and an ODV source 108, in accordance with one example embodiment of the present disclosure.

Some or all of the functionality of RFOV video generator system 102, VR display device 111 and ODV source may be commonly hosted on a physical computing device. In the event that functionality is provided by different physical devices, the components of system 150 are enabled to communicate with each through communications links that may be implemented using wired or wireless communications methods.

ODV source 108 may for example include a memory storage device that can store an ODV, or may be connected to an on-line source through which an ODV can be downloaded or streamed. In some embodiments, the ODV video source 108 may be co-hosted on a computing device with the RFOV video generator system 102 or be integrated into the RFOV video generator system 102. ODV video source 108 stores or has access to a copy of an ODV 281.

The ODV 281 may be transmitted, frame 282 by frame 282 and in chronological order, to VR display device 111, which can include a head mounted display (HMD) 110 worn by a user. VR display device 111 may be implemented across different physical components, for example some of the functionality of VR display device 111 may be integrated on a common computing system as RFOV video generator system 102 with the HMD functionality being implemented on a different physical device. In some examples, all or most of the functionality of VR display device 111 may be integrated into a single physical device.

For each ODV frame 282, the VR display device 111 renders a respective image 160 that is derived from the ODV image data 283. Image 160 is rendered by VR display device 111 on a display screen of the HMD 110. The VR display device 111 may be operable to display each ODV frame 282 in its original resolution and size, or may display only a portion of each ODV frame 282. In some embodiments, the VR display device 111 may be configured to display, in a first mode (e.g., a recording mode), an ODV image 282R with a viewfinder, which may include visual indicators, indicating a boundary that corresponds to an RFOV image 160 (e.g., as represented by image region 160Z in FIG. 2) being captured by the RFOV video generator system 102 for the respective ODV frame 282. In some embodiments, the VR display device 111 may be configured, in a second mode (e.g. an editor mode), to display an ODV frame image 282R as well as a corresponding RFOV video frame image 160 in the same display.

One or the other of the VR display device 111 or ODV source 108 may be further configured to send the ODV frames 282 to the RFOV video generator system 102, which based on real time or near real time user input data 115 from the VR display device 111, records or edits virtual reality field of view (VRFOV) frame data about each ODV frame 282 being displayed by the VR display device 111. The user input data 115 may take a number of formats, including, without limitation, data that is generated by sensors of the VR display device 111 that measure: a user head orientation, a user hand gesture, a user voice command, a user eye movement, and a user input from a control unit of the VR display device 111. The control unit of the VR display device 111 may be a separate controller that can detect user input data 115 via various types of hand motion (e.g. clicking, pressing or swiping).

In the illustrated embodiment, RFOV video generator system 102 includes a RFOV virtual recording unit 103, an RFOV virtual recording playback and editing unit 105 and an RFOV video content generation unit 107.

RFOV virtual recording unit 103 is configured to record, in system storage or memory, a respective virtual reality field of view (VRFOV) frame 166 for each of a plurality of ODV frames 282 of an ODV 181. The VRFOV frame 166 for each ODV frame 282 comprises data that includes a frame identifier 109 for the ODV frame 282 (in some example frame identifier 109 may be the same as the timestamp used as a ODV frame identifier 284), and spatial parameters 106 indicating a subset of ODV image data 283 of the ODV frame 283 corresponding to a field of view (FOV) of the ODV displayed on the HMD display screen of the VR display device 111. In example embodiments, spatial parameters 106 point to a subset of the pixels of ODV image data 283 of the ODV frame 283.

In example embodiments, RFOV virtual recording unit 103 is configured to begin recording data for virtual reality field of view (VRFOV) frames 166 upon detecting predetermined user input data 115 (e.g. a user click on a button or a voice command). Once recording, RFOV virtual recording unit 103 generates virtual RFOV video data 168 that includes VRFOV frames 166 corresponding to the rendered FOV frame images 160 displayed on the display screen of the VR display device 111. The spatial parameters 106 included in the VRFOV frame 166 for each frame image may represent (e.g., point to) image data for a regular FOV having a specific size, which can be pre-determined based on a user setting. For example, if a desired RFOV video output is 500×500 pixels per frame, the regular FOV presented by the VR display device 111 may have a size of 500×500 pixels.

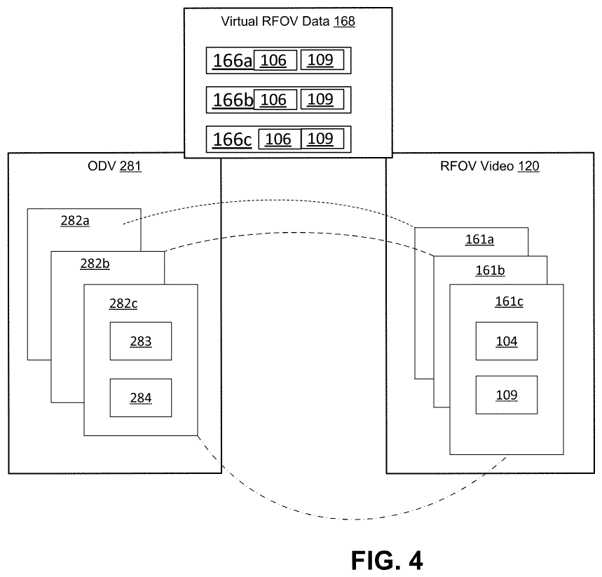

By way of example, FIG. 4 shows a block diagram representing an ODV 281 that comprises 3 ODV frames 282a, 282b, 282c (each including respective ODV image data 283 and a respective timestamp identifier 284) along with virtual RFOV data 168 that has been recorded by RFOV virtual recording unit 103 in respect of the 3 ODV frames 282a, 282b, 282c. In this regard, virtual RFOV data 168 includes VRFOV frame 166a. 166b, and 166c corresponding to ODV frames 282a, 282b and 282c. By way of example, VRFOV frame 166a includes spatial parameters 106 that indicate (e.g., point to) a subset of ODV image data 283 of the ODV frame 282a corresponding to a field of view (FOV) (e.g., RFOV frame image 160) displayed on a display screen of the VR display device 111 during the recording. VRFOV frame 166a also includes a timestamp identifier 109 that maps to ODV frame 282a (e.g., may be identical to timestamp identifier 284).

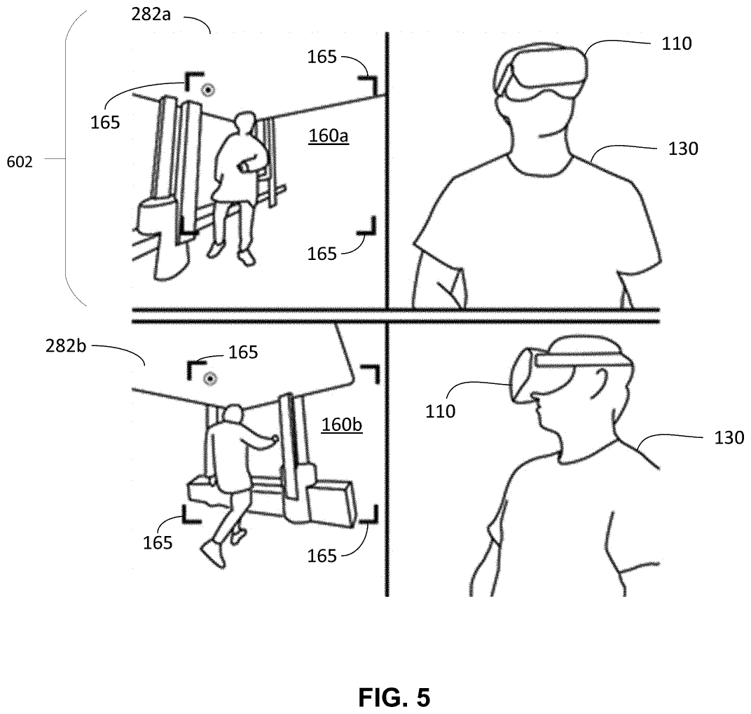

Referring, by way of example, to FIG. 5, the upper region 602 illustrates the FOV on HMD 110 of VR display device 111 in respect of ODV fame 282A. The VR display device 111 can present a FOV using visual indicators 165, so a user 130 can see which part (e.g., subset of ODV image data) of the ODV frame 282a is being virtually recorded as image 160a by the spatial parameters 106 of VRFOV fame 166a. As will be appreciated from FIG. 5, the FOV on HMD 110 of VR display device 111 is determined based on user input data 115 that is generated based on the orientation and position of the head of the user 130.

In example embodiments, the spatial parameters 106 are effectively one or more pointers that are sufficient to enable components of the RFOV video generator system 102 to determine, at a future time as described below, what image data needs to be extracted from ODV image data 283 in order to provide RFOV image data 104 for a RFOV frame 161a that corresponds to the RFOV frame image 106a. Accordingly, as will be explained in greater detail below, the spatial parameters 106 effectively are a virtual representation of a future RFOV video frame 16a that will be generated in the future by RFOV Video Content Generation Unit 107. A technical benefit of recording the spatial parameters 106 is that recording pointers to image data rather than the image data itself is computationally and memory light process, and, as described below, the spatial parameters can be subsequently edited in real time by RFOV Virtual recording playback and editing unit 105 during an editing stage by the user using the VR display device 111.

In some embodiments, the spatial parameters 106 may include a FOV size, which can be first set to a default size based on a desired output format of the RFOV video frame 161. The FOV size may be defined in terms of pixels, such as 1000×1000 pixels, which is a subset of the pixel size of the ODV image data 283 of an ODV frame 284. The FOV size may be affected by a zoom level. A zoom level may be represented as a zoom factor. For example, when the FOV is 1000 pixels by 1000 pixels, and a zoom factor of 2 is involved, the FOV may be re-sized to 500×500 pixels. Similarly, if a zoom factor of ½ is introduced, the FOV may be re-sized to 2000×2000 pixels. In other words, a FOV size may be divided by a given zoom factor to arrive at a new FOV size. When a user is first viewing an ODV 281 via the VR display device 111, the zoom factor is assumed to be 1, e.g., no zoom. The user may choose to manually change the zoom factor if he so desires, by user input data 115, such as by clicking on a controller of the VR display device 111, or by mid-air hand motions, as will be described below in connection with RFOV virtual recording playback and editing unit 105.

Once virtual RFOV data 168 has been recorded in respect of a ODV 281, immersive editing can be performed using the virtual recording playback and editing unit 105 (the “playback and editing unit 105”). In this regard, playback and editing unit 105 is configured to cause VR display device 111 to display a virtual RFOV video that corresponds to the ODV 281 based on the virtual RFOV data 168. In particular, playback and editing unit 105 has access to the original ODV 281 directly or indirectly from the ODV source 108, and is configured to cause a video frame image 160 to be displayed based on a respective ODV frame 282 using the spatial parameters 106 and frame identifier 108 included in VRFOV frame 166. Therefore, the system 102 can avoid duplicating ODV image data for storing and editing playback that occur as interim steps on the way to generating an RFOV video 120, resulting in faster video processing and more efficient use of computing resources. As the playback and editing unit 105 generates and displays each RFOV frame image 160 corresponding to a virtual RFOV video frame 166 on the display screen of the VR display device 111, a user can edit the virtual video frame as needed. User input data 115 may be received by the playback and editing unit 105 and the corresponding spatial parameter 106 used to generate the RFOV video frame image 160 may be modified based on the user input data 115. The playback and editing unit 105 can display the frame image 160 that corresponds to the modified virtual RFOV video frame 166 based on the modified spatial parameters in real time (or near real time), such that the user is able to view content editing options for a proposed final RFOV video frame 160 via the VR display device 111.

In some embodiments, a user can confirm through a predefined user input that the recorded spatial parameters 106 in respect of an ODV frame 282 are to be updated. The change in the spatial parameters 106 will then be recorded, providing updated spatial parameters 106.

The changes made to spatial parameters 106 in respect of a present virtual RFOV video frame 166 may be carried forward and applied to spatial parameters 106 for future virtual RFOV video frames 166 (e.g., successive frames in a time sequence), or carried backward and applied to spatial parameters 106 of past virtual RFOV video frames 166 (e.g., previous frames in a time sequence). In some examples, the time duration for such edits may be user defined, for example 10 seconds in both directions. The playback and editing unit 105 may be configured to store one or more versions of each VRFOV frame 166 for each video frame image 160, where each version of VRFOV frame 166 for a given RFOV video frame image 160 may be specifically associated with a creation or edit time, or a version number. This way, a user may choose which version of edit to apply to a video frame image 160 at will, and can un-do or re-do any edit. In some embodiments, a user input data 115 such as a voice command or a hand motion may be required to activate a playback mode or an editing mode of the playback and editing unit 105.

FIG. 5 shows examples of rendered RFOV frame images 160a, 160b (that can correspond to future RFOV video frames 161a, 161b) as displayed by a VR display device 111 worn by a user 130. Both the RFOV virtual recording unit 103 and the playback and editing unit 105 can display a RFOV frame images 160a, 160b based on a user's head orientation. In some embodiments, the RFOV virtual recording unit 103 or the playback and editing unit 105 can display the RFOV video frame images 160a, 160b within a corresponding ODV frame 282a, 282b. One or more visual indicators 165 may be used to indicate a boundary of the RFOV frame images 160a, 160b within the corresponding ODV frame 282a, 282b, so that the user 130 may see the precise RFOV frame images 160, 160 being captured for future RFOV video frames 161a, 161b by the RFOV video generator system 102 at any given moment.

The user 130 can move and edit the FOV of a RFOV video frame image 160 by moving the visual indicators 165, in order to view different angles or perspectives at any given point in time during playback of the ODV video. For example, at each point in time when an ODV frame 282a, 282b is presented, the user 130 can move, rotate, or zoom in/out the FOV (as presented by the visual indicators 165) in various directions and/or angles to view different objects or scenes within the ODV frame 282a, 282b. User input data 115 may include a head orientation (including a relative change), a hand gesture, a voice command, an eye movement, and an input from a control unit of the VR display device 111. For example, the user 130 can rotate his head in various directions to record VRFOV frame 166a, 166b in respect of a first RFOV video frame image 160a and a second RFOV video frame image 160b.

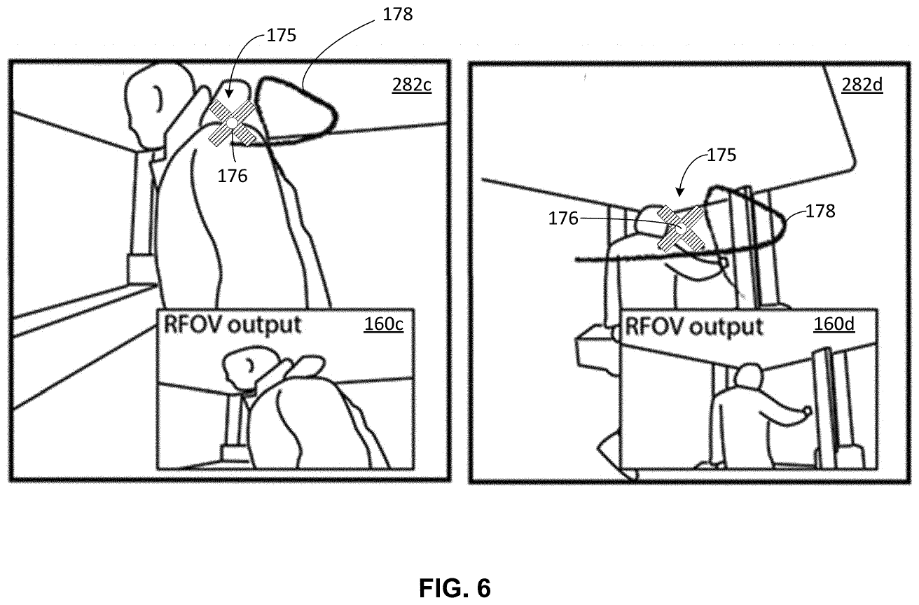

In some embodiments, the RFOV virtual recording unit 103 or the playback and editing unit 105 can configure the VR display device 111 to display a RFOV video frame image overlaying a corresponding ODV frame, shown in FIG. 6. In this embodiment, the RFOV virtual recording unit 103 or the playback and editing unit 105 configures the VR display device 111 to present the RFOV video frame image 160c, 160d as a view-within-a-view. A visual indicator 175 (represented by a shaded cross in FIG. 6) indicating a RFOV image center 176 can be seen on the ODV frame 282c, 282d, and the corresponding RFOV video frame image 160c, 160d being displayed within the ODV frame 282c, 282d is determined based on the position of the RFOV center 176 and a FOV size (e.g. w×l pixels). In some embodiments, the RFOV virtual recording unit 103 or the playback and editing unit 105 can configure the VR display device 111 to show an optional visual indicator 178 representing a virtual trajectory of the FOV as captured by a virtual RFOV camera positioned on or around the user's head, if the VR display device 111 is a HMD.

Referring back to FIG. 3, the playback and editing unit 105 may, based on the user input data 115 received from VR display device 111, update one or more spatial parameters 106 for one or more VRFOV video frames 166 to generate a final set of spatial parameters 106 for each of the RFOV video frames 166. For some of the VRFOV video frames 166, the spatial parameters 106 may remain unchanged, so an updated or final set of spatial parameters 106 may be optional for some RFOV video frames 166. In some embodiments, for a given ODV 281 having a plurality of ODV frames 282, there exists a corresponding RFOV video frame 166 for each ODV frame 282, and the corresponding RFOV video frame 166 has at least one set of spatial parameters 104, 106. In some cases, the user 130 may choose to edit only a portion of the entire ODV 281 stored on the ODV source 108, in which case, only the RFOV video frames corresponding to the chosen portion of the ODV 281 will be generated and spatial parameters recorded, edited and finalized.

The final set of spatial parameters 106 (or where a final set of spatial parameters 106 is not available, the original set of spatial parameters 106) for each RFOV video frame 160 may be sent to a RFOV video content generation unit 107 to generate a RFOV video 120. Based on the final set of spatial parameters 106 (or original spatial parameters 106 where appropriate) and a respective ODV frame identifier 109 for each RFOV video frame 166, the RFOV video content generation unit 107 can retrieve the necessary ODV image data 283 from the ODV source 108 and construct each RFOV video frame image 160 accordingly. At this stage, for each RFOV video frame 166, the RFOV video content generation unit 107 may extract a subset of ODV image data 283 from a corresponding ODV frame 282 (as identified by the ODV frame identifier 109), the subset of ODV image data 283 containing spatially arranged image data, and store the extracted subset of ODV image data as RFOV image data 104 for the RFOV video frame 161. The RFOV video content generation unit 107 may perform this operation for each RFOV video frame 161 in chronological order, and the final RFOV video 120 may be stored with a unique identifier associating the RFOV video 120 to a corresponding ODV 281, or a portion thereof.

Video generation system 102 (the “system 102”) may in various embodiments include a physical computer (i.e., physical machine such as a desktop computer, a laptop, a server, etc.) or a virtual computer (i.e., virtual machine) provided by, for example, a cloud service provider. Referring to FIG. 12, the system 102 may be implemented using a processing system 1170 that includes a processor 1172 coupled to a memory 1180 via a communication bus 1182 or communication link which provides a communication path between the memory 1180 and the processor. In some embodiments, the memory 1180 may include one or more of a Random Access Memory (RAM), Read Only Memory (ROM), persistent (non-volatile) memory such as flash erasable programmable read only memory (EPROM) flash memory. The processor 1172 may include one or more processing units, including for example one or more central processing units (CPUs), one or more general processing units (GPUs), one or more tensor processing units (TPUs), and other processing units. The processor 1172 may also include one or more hardware accelerators.

In some embodiments, the processor 1172 may also be coupled to one or more communications subsystems (not shown) for exchanging data signals with a communication network, and/or one or more user interface subsystems (not shown) such as a touchscreen display, keyboard, and/or pointer device. The touchscreen display may include a display such as a color liquid crystal display (LCD), light-emitting diode (LED) display or active-matrix organic light-emitting diode (AMOLED) display, with a touch-sensitive input surface or overlay connected to an electronic controller. Alternatively, the touchscreen display may include a display with touch sensors integrated therein.

The memory 1180 f the system 102 includes non-transient storage having stored thereon instructions 1182 of software systems, including a RFOV virtual recording unit 103, a RFOV virtual recording playback and editing unit 105, and a RFOV video content generation unit 107, which may be executed by the processor 202 to generate a RFOV video 120 from an ODV 281 stored in a ODV source 108.

The memory 1108 also stores a variety of data. The data may include ODV data 281, including data representative of a plurality of ODV frames 282a, 282b, 282c in chronological order. An ODV frame 282a, 282b, 282c may include ODV image data 283 and a timestamp 284. The data 280 may also include RFOV video 120 that includes a plurality of RFOV video frames 161a, 161b, 161c. RFOV video frames 161a, 161b, 161c includes, image data 104 and an ODV frame identifier 109. In some embodiments, the ODV frame identifier 109 for a RFOV video frame 160c may be mapped to, or include, the timestamp 284 of a corresponding ODV frame 282c. The data may include user input data 115 received from the VR display device 111. The data may further include a generated RFOV video 120. The data may include Virtual RFOV data 168 as well, which includes recorded spatial parameters 106 and ODV frame identifier 109.

System software, software modules, specific device applications, or parts thereof, may be temporarily loaded into a volatile storage, such as RAM of the memory which is used for storing runtime data variables and other types of data and/or information. Other data received by the system 102 may also be stored in the RAM of the memory. Although specific functions are described for various types of memory, this is merely one example, and a different assignment of functions to types of memory may also be used.

The system 102 may be a single device, for example a collection of circuits housed within a single housing. In other embodiments, the system 102 may be distributed across two or more devices or housings, possibly separated from each other in space. The communication bus may comprise one or more communication links or networks.

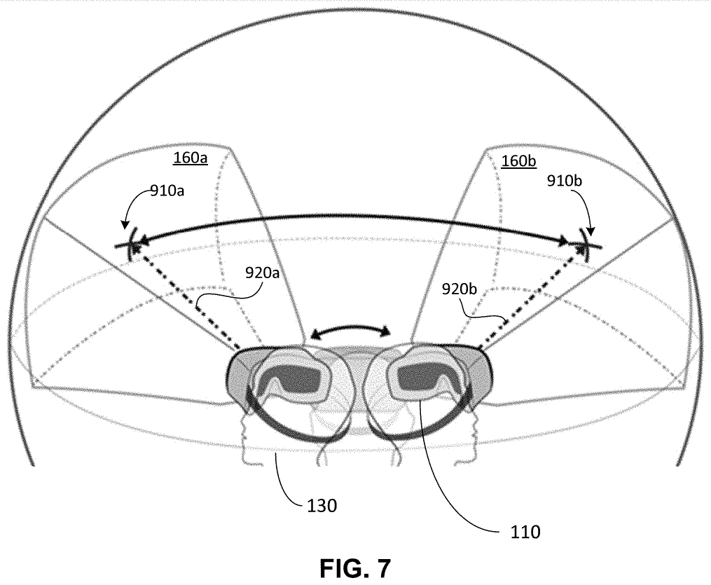

FIG. 7 illustrates a user 130 in motion wearing a HMD 110 of VR display device 111. The VR display device 111 includes an HMD 110 positioned around the user's head. In some embodiments, a position and orientation of the HMD 110 can be used to represent, or calculate, a corresponding position and orientation of the user's head. For example, when the user 130 is looking west, his head orientation can be represented by, or calculated based on (using known methods), an orientation of the HMD 110. The user's head orientation can be used to calculate a viewpoint 910a and a view direction 920a. The viewpoint 910a is assumed to be a visual focus for the user 130, which coincides with a center 176 of the RFOV video frame image 160a.

In some embodiments, a viewpoint 910a or a center 176 of the RFOV video frame image 160a may be one pixel, in which case the coordinates of the viewpoint 910a or the center 176 for the corresponding VRFOV video frame 166 and final RFOV video frame 161 may be determined based on the coordinates of the pixel.

In some embodiments, a viewpoint 910a or a center 176 of the RFOV video frame image 160a may include multiple pixels in a cluster, in which case the coordinates of the viewpoint 910a or the center 176 may be determined based on an average value based on the respective coordinates of the multiple pixels in the cluster.

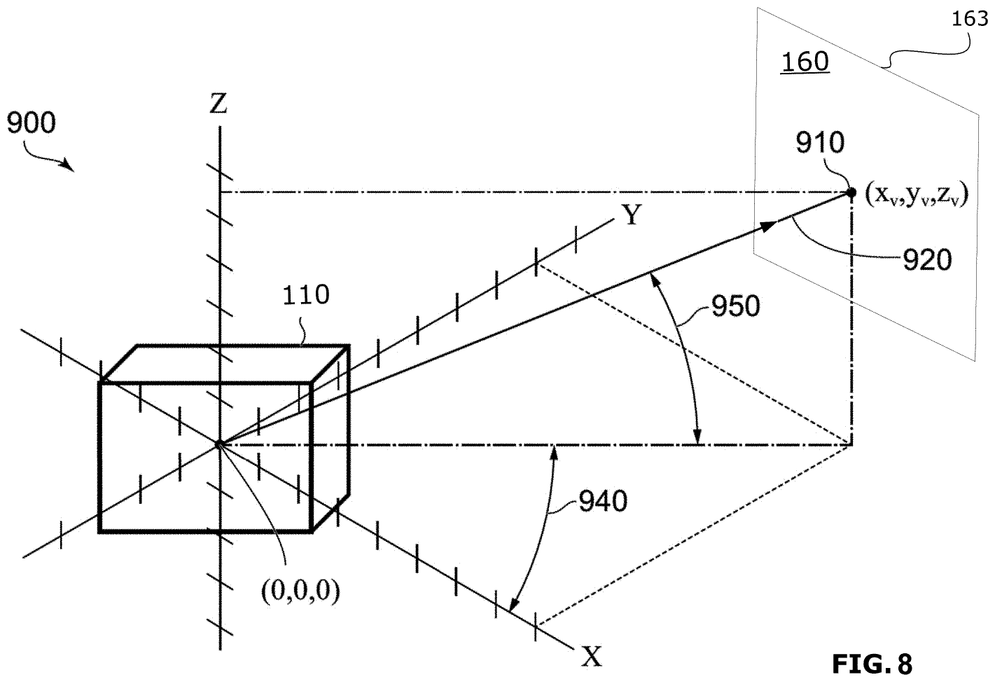

The position of the viewpoint 910a along with a FOV size (e.g. 1000×1000 pixels) can be used to determine a boundary 163 of a VRFOV video frame 166a, as further described below in connection with FIG. 8. Similarly, when the user is looking east, his head orientation can be represented by an orientation of the HMD 110, which can be used to calculate a second viewpoint 910b and a second view direction 920b, as well as a boundary 163 of a RFOV video frame 160b. The head orientation of the user 130, which may be based on an orientation of the VR display device 111, may be obtained using embedded sensors, such as inertial measurement unit (IMU) or other kinds of sensors (e.g. optical sensor), of the VR display device 111.

FIG. 8 illustrates an example three-dimensional (3D) coordinate system of HMD 110 of a VR display device 111 (simplified to a square box in dot-dash lines), with its center overlapping with the origin (0, 0, 0) of a 3D coordinate system 900. The coordinate system 900 has three axis X, Y, and Z. As a user 130 looks at a specific point in an ODV frame 282 shown by the HMD 110 at a given time in point, a viewpoint 910, which may be taken to mean a viewpoint 910 of a virtual camera situated at the user's head, can be represented by the coordinates (xᵥ, yᵥ, zᵥ) in the coordinate system 900. If the virtual camera were to project a virtual ray in a forward direction, the virtual ray would intersect the virtual sphere at viewpoint 910. As mentioned, this viewpoint 910 coincides with a center 176 of a RFOV video frame image 160 of the ODV frame 282. A straight line connecting the origin (0, 0, 0) and the viewpoint 910 (xᵥ, yᵥ, zᵥ) forms a view direction 920 along the virtual ray, which has an angle 940 from X axis, and an angle 950 from the XY plane. The precise boundary 163 of the VRFOV video frame 166 corresponding to rendered frame image 160 can be obtained by generating a 2D viewing plane that is perpendicular to the view direction 920 at the viewpoint 910 (xᵥ, yᵥ, zᵥ), having a center 176 at the viewpoint 910 (xᵥ, yᵥ, zᵥ), and a given FOV size (e.g, 1000×1000 pixels). If a zoom level is specified in the system, or via user input data 115 from the VR display device 111, the zoom level may affect the FOV size, thereby the boundary 163 of the VRFOV video frame 166. For example, a zoom level such as a zoom factor of 2 means that the FOV size is divided by 2, and therefore the boundary 163 that is reflected by the spatial parameters 106 of the VRFOV video frame 166 is updated based on the new FOV size.

For each VRFOV video frame 166 corresponding to rendered frame image 160, the coordinates representing the viewpoint 910 as well as the center 176 of the VRFOV video frame 166 can be represented using any one of: a set of Cartesian coordinates, a set of coordinates in quaternion orientation (the “quaternion coordinates”), or a set of coordinates in Euler Angles (the “Euler Angles”). The values for one or more sets of coordinates may be included as spatial parameters 106. That is, the spatial parameters 106 may include at least one set of coordinates representing the center 176 of the VRFOV video frame 166, and may optionally include the representation of the center 176 in other coordinate systems. A default setting in the system 102 may stipulate which coordinate system is to be used to store the spatial parameters 106 associated with each RFOV video frame 166 for an ODV 281.

For any viewpoint 910 or center 176 of the VRFOV video frame 166, representation in one set of coordinates, such as the Cartesian coordinates, may be used to compute a corresponding representation in a different set of coordinates, such as the Euler Angles or the quaternion coordinates. For example, given a set of Cartesian coordinates (x, y, z), the Euler Angles (yaw ψ, pitch θ, and roll φ) can be calculated per below:

ψ=arc sin(X₂/\sqrt{1−X₃²}),

θ=arc sin(−X₃),

ϕ=arc sin(Y₃/\sqrt{1−X₃²}).

For another example, given a set of Euler Angles (yaw ψ, pitch θ, and roll ϕ), the quaternion coordinates can be calculated per below:

$${q}_{1 B} = [ \begin{matrix}cos ( ψ / 2 ) \\ 0 \\ 0 \\ sin ( ψ / 2 )\end{matrix} ] [ \begin{matrix}cos ( θ / 2 ) \\ 0 \\ sin ( θ / 2 ) \\ 0\end{matrix} ] [ \begin{matrix}cos ( ϕ / 2 ) \\ sin ( ϕ / 2 ) \\ 0 \\ 0\end{matrix} ] = [ \begin{matrix}cos ( ϕ / 2 ) cos ( θ / 2 ) cos ( ψ / 2 ) + sin ( ϕ / 2 ) sin ( θ / 2 ) sin ( ψ / 2 ) \\ sin ( ϕ / 2 ) cos ( θ / 2 ) cos ( ψ / 2 ) - cos ( ϕ / 2 ) sin ( θ / 2 ) sin ( ψ / 2 ) \\ cos ( ϕ / 2 ) sin ( θ / 2 ) cos ( ψ / 2 ) + sin ( ϕ / 2 ) cos ( θ / 2 ) sin ( ψ / 2 ) \\ cos ( ϕ / 2 ) cos ( θ / 2 ) sin ( ψ / 2 ) - sin ( ϕ / 2 ) sin ( θ / 2 ) cos ( ψ / 2 )\end{matrix} ] .$$

The spatial parameters 106 also includes a FOV size, which may be set to a default value, and may be updated based on a zoom level or a zoom factor. The zoom level may be assumed to be 1 in the absence of any user input data 115.

User input data 115 such as certain hand gestures and maneuvers may be used to view and edit the center 176 or the boundary 163 of the VRFOV video frame 166. For example, the user may use head motion or hand gesture to move the video frame image 160 that is rendered in respect of a VRFOV video frame 166 from a first viewpoint 910a to a second viewpoint 910b. The user may send voice commands, through a speech recognition and processing software, to the system 102 for manipulating the rendered video frame images 160. Regardless of the input means used by the user 130 to view and edit the VRFOV video frame 166, the system 102 can determine (or update) and store the spatial parameters 106 associated with each VRFOV video frame 166. In some embodiments, spatial parameters 106 may only be updated or edited if a viewing event has occurred. A viewing event may be defined as an event during which the user has viewed any particular ODV frame 282 or VRFOV frame 166 with the same head orientation for a period of a minimum threshold dwell time. The minimum threshold dwell time may be set to a default value (e.g., 3 or 5 seconds), and may be changed from time to time by the system 102 or the user via user input data 115.

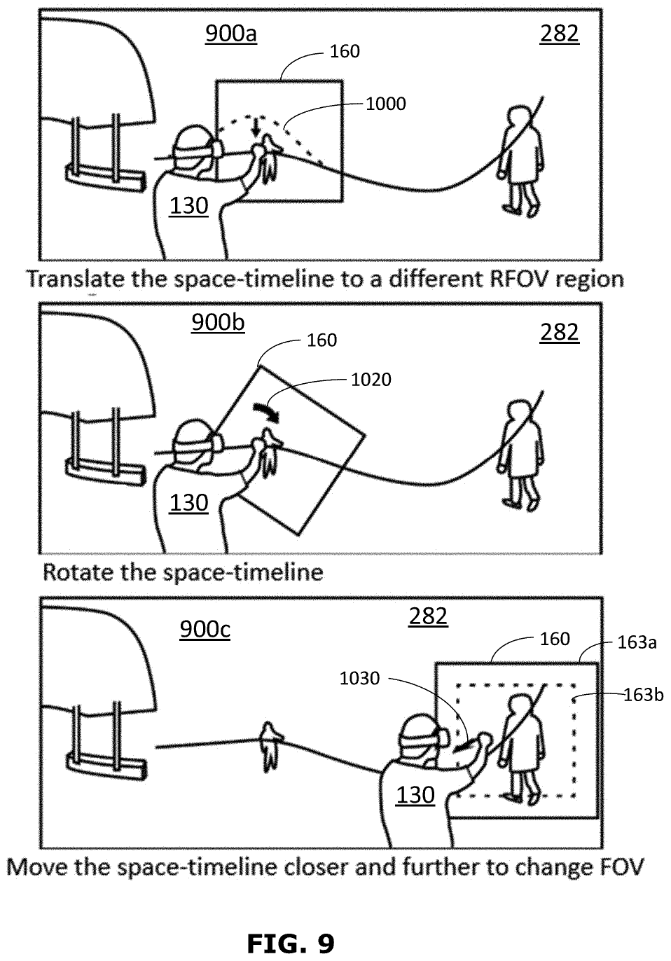

FIG. 9 illustrates three examples of a user 130 editing VRFOV video frame 166, corresponding to rendered frame image 160 within a corresponding ODV frame 282 through a VR display device 111. The three examples are represented in three ODV image renderings 900a, 900b, 900c, of the ODV frame 282. The user 130 may activate an editing mode of the system 102 through a user input data 115. The playback and editing unit 105 of the system 102 may, upon an activation of the editing mode, display ODV image 900a that includes a RFOV video frame image 160 within a corresponding ODV frame 282. The user 130 may pause, if needed, a virtual representation of RFOV video at VRFOV frame 166 in order to consider and make edit to the VRFOV frame 166. As described above, the system 102 can determine (or update) and store the spatial parameters 106 associated with each VRFOV video frame 166 based on one or more user input data 115, such as a translation movement 1000 rendering 900a), a rotation movement 1020 (rendering 900b), and/or a zoom movement 1030 (rendering 900c). Each of these movements may be determined based on a variety of user input data 115 such as hand motion, hand gesture, body motion (other than hand motion), head orientation, voice command, and input through a control unit (e.g. a handheld controller) of the VR display device 111.

For example, in the case of rendering 900a, translation movement 1000 represents a user input data 115 to move the center 176 of the RFOV video frame image 160 along a horizontal or vertical direction, while keeping the same distance between the center 176 of the RFOV video frame image 160 and the user 130 in the virtual reality. The user input data 115 can be hand gesture as shown in FIG. 9, or input through a handheld controller which can cast a virtual ray that focuses on a particular point of the display screen of the VR display device 111. Once the new center 176 of the RFOV video frame image 160 is determined based on the user input data 115, an updated set of spatial parameters 106 may be generated for the VRFOV frame 166 based on the location of the new center 176 of the rendered RFOV video frame 160.

As shown in rendering 900b, A rotation movement 1020 represents a user input data 115 to rotate the entire RFOV video frame image 160 around its center 176, while keeping the center 176 fixed within the ODV frame 282. The rotation can be calculated by a difference in the Euler Angle (e.g., the roll angle) as the user 130 performs the rotation manipulation. For example, the user 130 may begin the rotation with his right-hand palm facing down, and finishes with the palm facing left, which rotates the RFOV video frame image 160 by 90 degrees clockwise around its center 176. The difference in one or more Euler Angles can be measured by a tracking mechanism (provided by the VR display device 111) that tracks a user's hands, or if the user 130 is using a handheld controller to generate the rotation movement 1020, the difference in Euler Angles can be determined using an embedded IMU sensors within the controller. The difference in the Euler Angle may be, if needed, converted to a value in the quaternion coordinate system. The spatial parameters 106 for the corresponding VRFOV frame 166 may be updated based on the difference in Euler Angles (or quaternion coordinates) and stored as a final set of spatial parameters 106 that can be applied to extract image data for the final RFOV video frame 161.

As seen in rendering 900c, zoom movement 1030 represents a user input data 115 to move the entire RFOV video frame image 160 closer or further away from the user 130. This motion in effect changes a FOV size, which is also part of the spatial parameters 106. Prior to the zoom movement 1030, the RFOV video frame image 160 may have a first FOV size as indicated by a boundary 163a, and after the zoom motion 1030, the RFOV video frame image 160 may have a second FOV size as indicated by a different boundary 163b. The first FOV size may be a default size or a previously edited size by the user 130. The FOV size may have a maximum value and a minimum value, which may be pre-determined by the system 102 or a user 130.

A given distance d between the origin [0, 0, 0] of the VR display device 111 (which represents a position of the user 130) and a specific viewpoint 910 (which represents a center 176 of the RFOV video frame 160, see e.g., FIG. 8) may correspond to a specific zoom level or factor F. For instance, for every movement or displacement of 10 centimetres along the view direction 920 towards the user 130, a FOV size may be divided by a zoom factor of 2. The ratio of d to F can be set by the system 102 or user 130, and as the center 176 of the RFOV video frame image 160 is moved closer or further away from the user 130, the total displacement Dₛ can be converted to a corresponding zoom factor Fₛ as a linear interpolation for changing the FOV size for the RFOV video frame 160c.

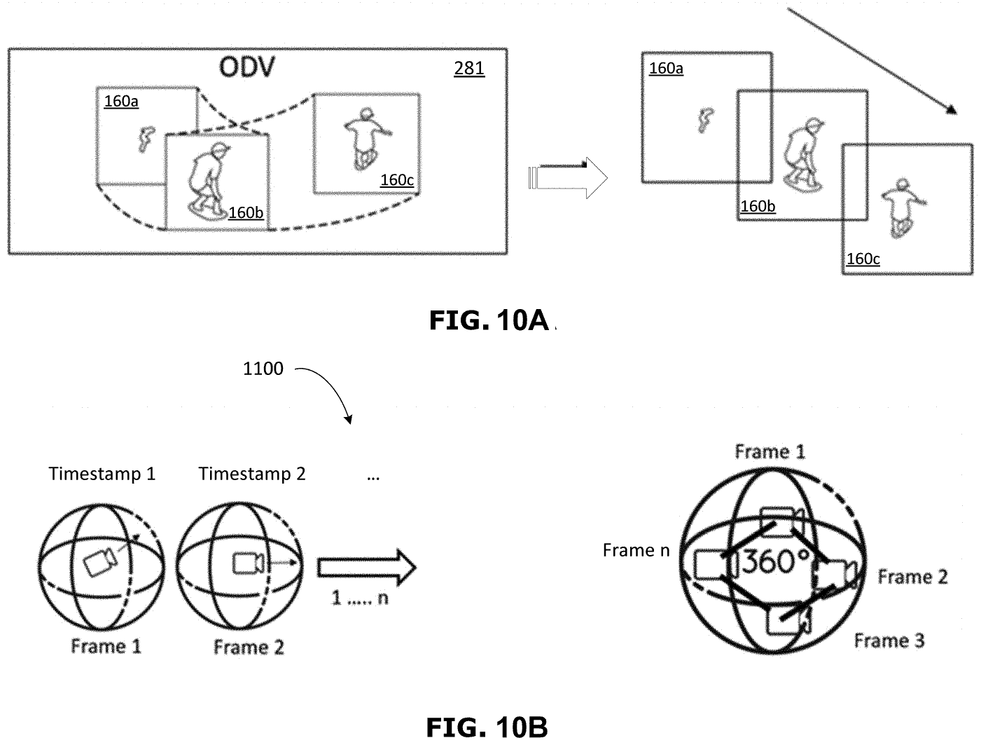

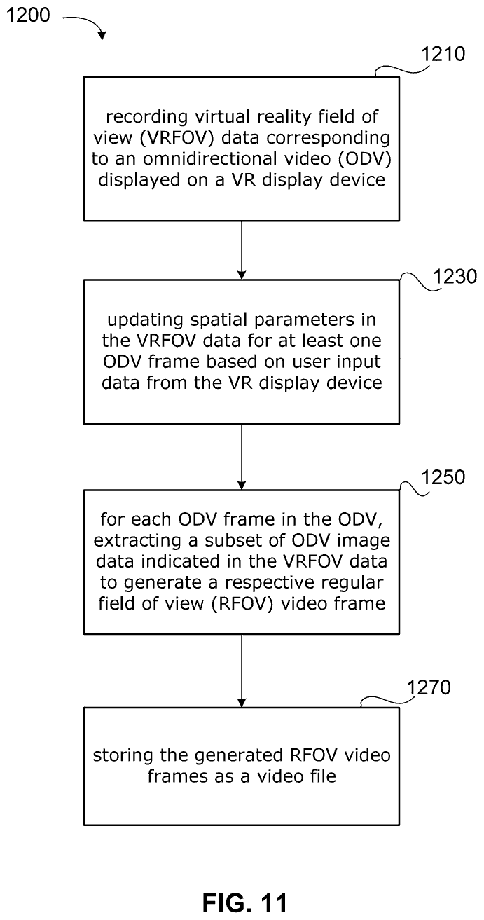

In some examples, a user can move his or her head through a series of ODV images to result in a spatial-temporal image timeline. FIG. 10A shows an example sequence of RFOV video frame images 160a, 160b, 160c corresponding to VRFOV frames 166a, 166b, 166c generated for different spatial image locations from three respective ODV frames 282a, 282b, and 282c of an ODV 281, in accordance with one example embodiment of the present disclosure. As described above, updated spatial parameters 106 can be used to construct multiple VRFOV video frames 166a, 166b, 166c. Each VRFOV video frame 166a, 166b, 166c has its own set of final spatial parameters 106, which may include a set of coordinates representing a center of the respective VRFOV video frame 166a, 166b, 166c, and a FOV size. Each RFOV video frame 166a, 166b, 166c also has a unique identifier associated with the spatial parameters 106, linking the spatial parameters 106 to a corresponding ODV frame 282a, 282b, 282c in the ODV 281. The unique identifier may be a timestamp of the corresponding ODV frame 282a, 282b, 282c for the respective RFOV video frames 166a, 166b, 166c. A sequence of RFOV video frames 161a, 161b, 161c therefore can be generated by extracting ODV image data from each ODV frame 282 based on the spatial parameters 106 of each VRFOV video frame and the unique identifier or timestamp associated with the spatial parameters 106. The sequence of RFOV video frames 161a, 161b, 1601 may in some examples be concatenated and converted to a RFOV video 120 in common video formats (e.g. mp4), to be viewed on conventional displays such as a computer screen or a TV screen.

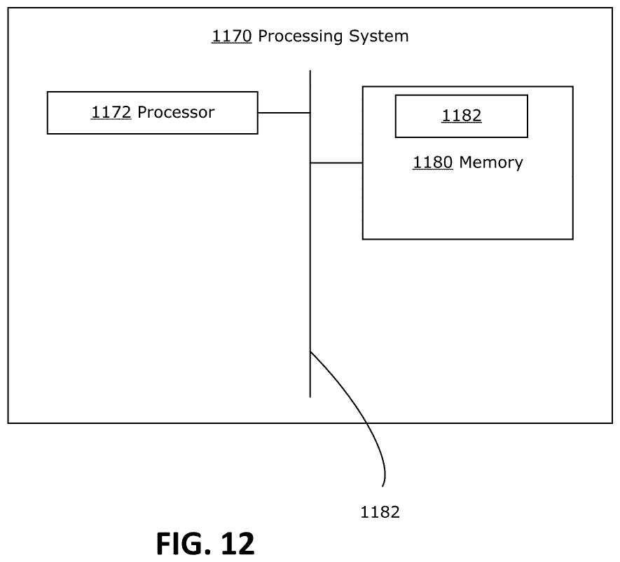

FIG. 1013 illustrates a simplified schematic diagram 1100 of generating a RFOV video 120 based on virtual RFOV data 168. Each set of spatial parameters 106 for a respective VRFOV video frame 166 may be viewed as a set of virtual camera parameters, and multiple RFOV video frames 166, each with a unique timestamp, may be viewed as video frame images captured by a single virtual camera in chronological order. The final RFOV video 120 can be viewed as a film captured by the virtual camera along a spatial camera trajectory generated based on the multiple sets of spatial parameters 106 in chronological order.

FIG. 11 illustrates an example process 1200 performed by an example RFOV video generation system 102, in accordance with one example embodiment of the present disclosure. The process 1200 may be performed by one or more processors of a computing device that is configured to implement RFOV video generation system 102 system 102. An ODV 281, a portion thereof, having a plurality of ODV frames 282 in chronological order, is received as input. Each of the ODV frames 282 includes spatially arranged ODV image data 283 and has a unique ODV frame timestamp 284. The spatially arranged ODV image data 283 may include pixels, and the location of the pixel within a tensor of the data 283 represents a specific location of the pixel in a rendered image, and the content of each pixel indicates a specific color of the pixel. The location can be represented using a set of quaternion coordinates, a set of Cartesian coordinates, or a set of Euler Angles. A color of the pixel can be represented in a red/green/blue (RGB) mode or a different color mode (e.g. CMYK color model). The unique ODV frame timestamp 284 may be used as a unique ODV frame identifier 109 for a corresponding VRFOV video frame 166 and final RFOV video frame 161 (which each correspond to a rendered frame image 160).

At step 1210, the system 102 records VRFOV data 168 corresponding to ODV frames 282 of an ODV 281 as the ODV frames 282 are displayed on a display screen of a VR display device 111. The VRFOV data 168 may include, for each ODV frame 282, a VRFOV frame that includes: spatial parameters 106 that indicate a subset of the ODV image data corresponding to a RFOV frame image 160 rendered by the VR display device 111 and a ODV frame identifier 109 that maps to an identifier, for example a timestamp 284, for the ODV frame 282. The ODV frame identifier 109 effectively associates the set of spatial parameters 106 to a given ODV frame 282 identified by the ODV frame identifier 109, so the system 102 knows which ODV frame 282 to look for when it needs to extract a subset of ODV image data 283 based on a given set of spatial parameters 106.

In some examples, the spatial parameters 106 define a center 176 of a respective RFOV video rendered frame image 160 that corresponds to VRFOV frame 166, where as a FOV size defines a boundary of the respective RFOV video frame image 160 when the center 176 has been determined. The FOV size can be first set to a default size (e.g. 1000×1000 pixels) based on a desired output format of the final RFOV video frame 161. The FOV size may be affected by a zoom level. A zoom level may be represented as a zoom factor. For example, when the FOV is 1000 pixels by 1000 pixels, and a zoom factor of 2 is involved, the FOV may be re-sized to 500×500 pixels. Similarly, if a zoom factor of ½ is introduced, the FOV may be re-sized to 2000×2000 pixels.

At step 1230, the system 102 updates the spatial parameters 106 in the stored VRVOF data 168 for at least one ODV frame 282 based on user input data 115 from the VR display device 111. The updated spatial parameters may be stored as updated or final spatial parameters 106 for the corresponding VRFOV video frame 166 of the at least one ODV frame 282. The system 102 can sense a head orientation of a user 130 wearing the VR display device 111 when the user 130 is viewing an ODV frame 282, and determine the VRFOV data 168, and in particular, the updated spatial parameters 106, for VRFOV frames 166 based on the head orientation. The head orientation of a user 130 can be calculated based on a position and orientation of the VR display device 111, when the VR display device 111 is an HMD, which may have embedded sensors to detect the user's head movements. Examples of the sensors may include optical sensor, IMU, gyroscopes, accelerometers, magnetometers, structured light systems, and eye tracking sensors. The VR display device 111 may also include a handheld controller that may be used by the user 130 to enter user input.

In addition to head orientation, the system 102 can also detect other types of user input data 115, such as hand gestures and arm movements, to determine a number of movements specifically used to update spatial parameters 106 of a VRFOV video frame 166 that corresponds to a rendered RFOV frame image 160. For example, a translation movement 1000 may be detected to move a center 176 of the RFOV video frame image 160 along a horizontal or vertical direction. A rotation movement 1020 may be detected to rotate the entire RFOV video frame image 160 around its center 176. A zoom movement 1030 may be detected to move the entire RFOV video frame image 160 closer or further away from the user 130. The spatial parameters 106 of each RFOV video frame 166 may be updated accordingly based on the movements 1000, 1020, 1030 and stored in the system 102 for further process.

In some embodiments, an edit to a present VRFOV video frame 166 may be carried forward and applied to future VRFOV video frames, or carried backward and applied to past VRFOV video frames.

At step 1250, for each ODV frame 282 in the plurality of ODV frames 282, the system 102 extracts a subset of the ODV image data 283 indicated in the VRFOV video frame 166 of the VRFOV data 168 to generate a respective RFOV video frame 160 based on the ODV frame 282. The VRFOF data 168 includes mapping data for each frame (e.g., final spatial parameters 106, and an ODV frame identifier 109) which are used to reconstruct multiple RFOV video frames 161. The final spatial parameters 106 may include a set of coordinates representing a center 176 of a respective VRFOV video frame 166 and a FOV size of the respective VRFOV video frame 166. The VRFOF data 168 also includes a unique ODV frame identifier 109 associated with the spatial parameters 106, linking the spatial parameters 106 to a corresponding ODV frame 282 in the ODV 281. The unique identifier 109 may be a timestamp 284 of the corresponding ODV frame 282.

A sequence of final RFOV video frames 161 are generated by extracting ODV image data 283 from each ODV frame 282 based on the mapping data specified in the VRFOV video frames 166, namely the spatial parameters 106 and the unique identifier 109 associated with the spatial parameters 106. At step 1270, the sequence of RFOV video frames 161 can then be concatenated and converted to a RFOV video 120.

The above described systems and methods may also be used to generate a new ODV based on an original ODV 281 stored in the ODV source 108. For example, if a viewing direction 920 is kept constant, and/or the FOV size is large enough to capture an ODV, the resulting video may be another ODV.

The embodiments described herein provide a user-friendly and computationally efficient system for viewing, editing and generating a RFOV video from an ODV, all within a virtual reality setting. Compared to desktop editing applications, the system described herein can encourage user participation by facilitating an immersive video viewing and editing experience, which may improve creativity as the user is no longer burdened with splitting his or her attention between spatial editing and temporal editing of the ODV. The resulting user interface, as presented through the VR display device, is an intuitive interface showing a RFOV video frame with in a corresponding ODV frame. In addition, user can easily edit the video content by head motion, hand motion, voice command, or other types of user input that are more natural than manually changing the values for the yaw-pitch-roll parameters for each frame. Lastly, the RFOV video frames are captured and recorded using spatial parameters and timestamps, instead of actual image data, which makes the system highly efficient and lightweight, and can be easily adapted for use by a user as long as a VR display device is available.

The steps and/or operations in the flowcharts and drawings described herein are for purposes of example only. There may be many variations to these steps and/or operations without departing from the teachings of the present disclosure. For instance, the steps may be performed in a differing order, or steps may be added, deleted, or modified.

The coding of software for carrying out the above-described methods described is within the scope of a person of ordinary skill in the art having regard to the present disclosure. Machine-readable code executable by one or more processors of one or more respective devices to perform the above-described method may be stored in a machine-readable medium such as the memory of the data manager. The terms “software” and “firmware” are interchangeable within the present disclosure and comprise any computer program stored in memory for execution by a processor, comprising Random Access Memory (RAM) memory, Read Only Memory (ROM) memory, EPROM memory, electrically EPROM (EEPROM) memory, and non-volatile RAM (NVRAM) memory. The above memory types are examples only, and are thus not limiting as to the types of memory usable for storage of a computer program.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several example embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods. In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein intends to cover and embrace all suitable changes in technology.

Although the present disclosure is described at least in part in terms of methods, a person of ordinary skill in the art will understand that the present disclosure is also directed to the various elements for performing at least some of the aspects and features of the described methods, be it by way of hardware, software or a combination thereof. Accordingly, the technical solution of the present disclosure may be embodied in a non-volatile or non-transitory machine-readable medium (e.g., optical disk, flash memory, etc.) having stored thereon executable instructions tangibly stored thereon that enable a processing device to execute examples of the methods disclosed herein.

The term “processor” may comprise any programmable system comprising systems using microprocessors/controllers or nano processors/controllers, digital signal processors (DSPs), application specific integrated circuits (ASICs), field-programmable gate arrays (FPGAs) reduced instruction set circuits (RISCs), logic circuits, and any other circuit or processor capable of executing the functions described herein. The term “database” may refer to either a body of data, a relational database management system (RDBMS), or to both. As used herein, a database may comprise any collection of data comprising hierarchical databases, relational databases, flat file databases, object-relational databases, object-oriented databases, and any other structured collection of records or data that is stored in a computer system. The above examples are example only, and thus are not intended to limit in any way the definition and/or meaning of the terms “processor” or “database”.

The present disclosure may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A method comprising:
recording virtual reality field of view (VRFOV) frame data for each of a plurality of omnidirectional video (ODV) frames of an ODV, the VRFOV frame data for each ODV frame including: (i) a frame identifier for the ODV frame; and (ii) spatial parameters indicating a subset of ODV image data of the ODV frame corresponding to a field of view (FOV) of the ODV displayed on a display screen of a virtual reality (VR) display device;
for each ODV frame in the plurality of ODV frames, extracting the subset of the ODV image data indicated by the spatial parameters in the VRFOV frame data to generate a respective regular field of view (RFOV) video frame; and
storing the generated RFOV video frames as a video file.

2. The method of claim 1, comprising, prior to extracting the subset of the ODV image data for each ODV frame,
updating the spatial parameters in the stored VRVOF frame data for at least one ODV frame in the plurality of ODV frames based on user input data from the VR display device.

3. The method of claim 1, wherein the spatial parameters for at least one ODV frame in the plurality of ODV frames comprise: a set of coordinates in quaternion orientation (“quaternion coordinates”), a set of Cartesian coordinates, or a set of coordinates in Euler Angles.

4. The method of claim 3, wherein the spatial parameters for at least one ODV frame in the plurality of ODV frames comprise a FOV size.

5. The method of claim 2, further comprising, for each of the plurality of ODV frames:
determining the spatial parameters for the ODV frame based on a sensed head orientation of a user wearing the VR display device when the user is viewing the ODV frame.

6. The method of claim 2, wherein the VR device comprises a head-mounted display and the user input data is received when the user is viewing the at least one ODV frame on the display screen of the head mounted display, the user input data being based on at least one of: a user head orientation, a user hand gesture, a user voice command, an user eye movement, and a user input from a control unit of the VR display device.

7. The method of claim 6, wherein updating the spatial parameters in the stored VRVOF frame data for the at least one ODV frame based on the user input data comprises:
updating at least one value from the spatial parameters based on a translation or rotation movement indicated by the user input data.

8. The method of claim 6, wherein updating the spatial parameters in the stored VRVOF frame data for the at least one ODV frame based on the user input comprises:
updating a FOV size in the spatial parameters based on a movement indicated by the user input data.

9. The method of claim 1, wherein the ODV frame identifier comprises a unique ODV frame timestamp for the ODV frame.

10. The method of claim 1, wherein the field of view (FOV) presented by the VR display device is pre-determined based on a user setting.

11. A system for processing a video, comprising:
a processor; and
a memory coupled to the processor, the memory tangibly storing thereon executable instructions that, when executed by the processor, cause the system to:
record virtual reality field of view (VRFOV) frame data for each of a plurality of omnidirectional video (ODV) frames of an ODV, the VRFOV frame data for each ODV frame including: (i) a frame identifier for the ODV frame; and (ii) spatial parameters indicating a subset of ODV image data of the ODV frame corresponding to a field of view (FOV) of the ODV displayed on a display screen of a virtual reality (VR) display device;
for each ODV frame in the plurality of ODV frames, extract the subset of the ODV image data indicated by the spatial parameters in the VRFOV frame data to generate a respective regular field of view (RFOV) video frame; and
store the RFOV video frames as a video file.

12. The system of claim 11, wherein the instructions, when executed by the processor, cause the system to:
prior to extracting the subset of the ODV image data for each ODV frame, update the spatial parameters in the stored VRVOF frame data for at least one ODV frame in the plurality of ODV frames based on user input data from the VR display device.

13. The system of claim 11, wherein the spatial parameters for at least one ODV frame in the plurality of ODV frames comprise: a set of coordinates in quaternion orientation (“quaternion coordinates”), a set of Cartesian coordinates, or a set of coordinates in Euler Angles.

14. The system of claim 13, wherein the spatial parameters for at least one ODV frame in the plurality of ODV frames comprise a FOV size.

15. The system of claim 12, wherein the instructions, when executed by the processor, cause the system to, for each of a plurality of ODV frames: determine the spatial parameters for the ODV frame based on a sensed head orientation of a user wearing the VR display device when the user is viewing the ODV frame.

16. The system of claim 12, wherein the user input data is received when the user is viewing the at least one ODV frame in the plurality of ODV frames on the display screen, and is based on at least one of: a user head orientation, a user hand gesture, a user voice command, a user eye movement, and a user input from a control unit of the VR display device.

17. The system of claim 16, wherein updating the spatial parameters in the stored VRVOF frame data for the at least one ODV frame based on the user input comprises:
updating at least one value from the spatial parameters based on a translation or rotation movement indicated by the user input data.

18. The system of claim 16, wherein updating the spatial parameters in the stored VRVOF frame data for the at least one ODV frame based on the user input comprises:
updating a FOV size in the spatial parameters based on a movement indicated by the user input data.

19. The system of claim 11, wherein the ODV frame identifier comprises a unique ODV frame timestamp for the ODV frame.

20. A non-transitory computer readable medium storing software instructions that configure a processor to method comprising:
record virtual reality field of view (VRFOV) frame data for each of a plurality of omnidirectional video (ODV) frames of an ODV, the VRFOV frame data for each ODV frame including: (i) a frame identifier for the ODV frame; and (ii) spatial parameters indicating a subset of ODV image data of the ODV frame corresponding to a field of view (FOV) of the ODV displayed on a display screen of a virtual reality (VR) display device;
for each ODV frame in the plurality of ODV frames, extract the subset of the ODV image data indicated by the spatial parameters in the VRFOV frame data to generate a respective regular field of view (RFOV) video frame; and
store the RFOV video frames as a video file.
